(19) United States
(12) Patent Application Publication
(10) Pub. No.: US 2010/0040738 A1
(43) Pub. Date: Feb. 18, 2010

(54) Extension Of Beverage Shelf-Stability By Solute-Ligand Complexes

(75) Inventor: Richard T. Smith, Rigefield, CT (US)

Correspondence Address: BANNER & WITCOFF, LTD.;and ATTORNEYS FOR CLIENT NO. 006943, 10 SOUTH WACKER DR., SUITE 3000, CHICAGO, IL, 60606, US

(73) Assignee: PepsiCo., Inc., Purchase, NY (US)

(21) Appl. No.: 12/510,348

(22) Filed: Nov. 3, 2009

Related U.S. Application Data
(60) Provisional application No. 61/086,850, filed on Aug. 7, 2008.

(51) Int. Cl. A23L 2/44; A23L 2/02; A23L 2/38; A23L 2/40; A23L 2/52; A23L 2/56; A23L 2/60; A23L 2/78

(52) U.S. Cl. 426/72; 426/532

(57) ABSTRACT

The present invention provides beverage preservative systems and beverage products comprising the beverage preservative systems. The beverage preservative system prevents spoilage by microorganisms in a beverage within a sealed container for a period of at least 16 weeks. The present invention reduces or eliminates the use of conventional preservatives that pose health and/or environmental concerns. In particular, the present invention is directed to a beverage product which comprises a cyclodextrin-antimicrobial complex.

### TECHNICAL FIELD

This invention relates to beverage preservative systems and beverage products comprising the preservative system. In particular, this invention relates to beverage preservative systems having formulations suitable to meet consumer demand for healthy and environmentally friendly ingredients.

### BACKGROUND

Many food and beverage products include chemical preservatives to extend the shelf-life of the product by inhibiting the growth of spoilage microorganisms (e.g., mold, yeast, bacteria) in the product for an extended period of time. However, some preservatives currently in use have been found to have detrimental health and/or environmental effects, or are not sufficiently stable. Therefore, there is market demand for food and beverage products which do not include these detrimental preservatives, and yet still possess extended shelf-life. There is also consumer demand for natural ingredients in food and beverage products.

For example, benzoic acid and its salts are commonly used in beverage products as preservatives. However, benzoic acid and its salts can react with ascorbic acid (Vitamin C), to form benzene, which is a carcinogen. Heat and light increase the rate of this reaction, so production and storage of beverage products under hot or bright conditions speeds up formation of benzene. Intake of benzene in drinking water is a public health concern, and the World Health Organization (WHO) and several governing bodies including agencies in the United State and the European Union have set upper limits for benzene content in drinking water of 10 ppb, 5 ppb, and 1 ppb, respectively.

Ethylenediamine tetraacetic acid (EDTA) and its salts are also common beverage product preservatives. EDTA is a metal ion chelator that sequesters metal ions and prevents their participation in catalytic oxidation reactions. EDTA at elevated concentrations is toxic to bacteria due to sequestration of necessary metals in the outer membrane of bacteria. However, EDTA is not bio-degradable, nor is it removed during conventional wastewater treatment. Recalcitrant chelating agents such as EDTA are an environmental concern predominantly because of their persistence and strong metal chelating properties. Widespread use of EDTA and its slow removal under many environmental conditions have led to its status as the most abundant anthropogenic compound in many European surface waters. River concentrations of EDTA in Europe are reported in the range of 10-100 μg/L, and lake concentrations of EDTA are in the range of 1-10 μg/L. EDTA concentrations in U.S. groundwater receiving wastewater effluent discharge have been reported in the range of 1-72 μg/L, and EDTA was found to be an affected tracer for effluent, with higher concentrations of EDTA corresponding to a greater percentage of reclaimed water in drinking water production wells.

The presence of chelating agents in high concentrations in wastewater and surface water has the potential to remobilize heavy metals from river sediments and treated sludge, although low and environmentally relevant concentrations seem to have only a very minor influence on metal solubility. Elevated concentrations of chelating agents enhance the transport of metals (e.g., Zn, Cd, Ni, Cr, Cu, Pb, Fe) in soils and enhance the undesired transport of radioactive metals away from disposal sites. Low concentrations of chelating agents may either stimulate or decrease plankton or algae growth, while high concentrations always inhibit activity. Chelating agent are non-toxic to many forms of life upon acute exposure; the effects of long-term low-level exposure are unknown. EDTA ingestion at high concentrations by mammals changes excretion of metals and can affect cell membrane permeability.

Polyphosphates are another common beverage product preservative. However, polyphosphates are not stabile in aqueous solution and degrade rapidly at ambient temperature. Degradation of polyphosphates results in unsatisfactory sensory issues in the beverage product, such as changes in acidity. Also, the shelf-life of the beverage product is compromised because of the reduced anti-microbial action from the reduced concentration of polyphosphate.

There are certain antimicrobials that are very effective against microorganisms, but are not effective in beverages as the antimicrobials will not go into solution. The present invention is directed toward providing new preservative systems for use in beverages that solubilize antimicrobials so that they will be effective in beverages.

The present invention is directed to providing new preservative systems for use in beverages as replacements for at least one currently used preservative that has detrimental health and/or environmental effects, or lack of sufficient stability. The present invention further provides new beverage preservative systems with improved sensory impact. The present invention further provides preservative systems without benzoic acid and/or reduced concentrations of sorbic acid. Some countries have regulatory restrictions on the use of sorbic acid in food and beverage products wherein the permitted concentration is less than the amount required to inhibit the growth of spoilage microorganisms by itself.

### SUMMARY

According to one aspect of the invention, a beverage preservative system is provided which comprises: an antimicrobially effective amount of a cyclodextrin-antimicrobial complex comprising cyclodextrin and an antimicrobial capable of forming a complex with the cyclodextrin; a pH of 2.5 to 7.5; wherein the beverage preservative system prevents spoilage by microorganisms in a beverage within a sealed container for a period of at least 16 weeks.

According to another aspect of the invention, a beverage product is provided which comprises: a beverage component and a beverage preservative system comprising: an antimicrobially effective amount of a cyclodextrin-antimicrobial complex comprising cyclodextrin and an antimicrobial capable of forming a complex with the cyclodextrin; a pH of 2.5 to 7.5; wherein the beverage preservative system prevents spoilage by microorganisms in a beverage within a sealed container for a period of at least 16 weeks.

These and other aspects, features, and advantages of the invention or of certain embodiments of the invention will be apparent to those skilled in the art from the following disclosure and description of exemplary embodiments.

### BRIEF DESCRIPTION OF THE DRAWING

FIG. 1 depicts an L₁:S₁ complex.

### DETAILED DESCRIPTION

The present invention is directed to a preservative system particularly suited for beverages having a pH no greater than pH 7.5 wherein the beverage is preserved for a period of at least 16 weeks. The preservative system comprises an cyclodextrin-antimicrobial complex. It was discovered that cyclodextrin could be used to solubilize certain water insoluble antimicrobials providing an effective preservative system. Such insoluble antimicrobials useful with the present invention include, for example, propyl paraben, methoxycinnamate, and trans, trans 2, 4, decadienal.

The present invention is particularly effective in preventing spoilage of beverages that can be initiated by either vegetative mold hyphae or spores of molds that are capable of germinating to a vegetative form when suspended in a beverage. Fungi forms that are inhibited by the preservative system include yeast, mold and dimorphic forms of fungi such as occurs in Yarrowia, Candida and, possibly, Brettanomyces. Mold spores may not be inactivated by the presence of the preservative system invention, but the spores are either prohibited from germinating in the presence of the invention or the vegetative form of the mold that results upon germination is prohibited from growth beyond a small number of cell cycle replications.

The present invention is directed to beverage preservative systems and beverage products comprising the preservative system. The preservative system makes use of an excipient (cyclodextrin) to enhance the availability of certain active antimicrobials to the surface of the microorganism. The antimicrobial activity of any molecule is favored by it exhibiting a low Topological Surface Area Polarity (TPSA). Restated, the lower the polarity exhibited by a molecule the greater the probability that it will function as an antimicrobial. With regard to beverage preservation, low polarity presents a problem in that low polarity chemicals exhibit reduced solubility in water. Water is a good solvent due to its polarity. The relatively small size of water molecules typically allows many water molecules to surround one molecule of solute. The partially negative dipoles of the water are attracted to the positively charged components of the solute. Similarly, solutes that are negatively charged are attracted to the partially positive dipole of water. Hence, ionic or polar substances (acids, alcohols and salts) are quite soluble in an aqueous phase. Non-polar molecules are “excluded” from interaction with water molecules. There is a tendency for water molecules to interact with one another in a manner that “fences in” non-polar substances. This phenomenon reflects that it is energetically more favorable for water molecules to hydrogen bond to each other than to engage in van der Waal interactions with non-polar surfaces. The lower the polarity of a molecule, the greater the tendency for the molecule to coalesce or aggregate when suspended in an aqueous system (beverage). For some types of compounds, aggregation can occur at the air-water interface wherein the more apolar portion of the molecule actually projects out of the surface into the air.

In instances where such aggregation occurs, there may be no commonly recognized analytical or macroscopic evidence of the onset of the aggregation phenomenon (phase separation or precipitate). Under such circumstance, the substance would appear to be more “soluble” than is actually the case. The aggregates may be uniformly distributed in solution (homogenous) but the individual molecules are not. If the molecule has antimicrobial activity, these phenomena might collectively be reflected in a seemingly paradoxical observation that the minimum inhibitory concentration of the compound exceeds the calculated solubility limit of the compound. At the molecular level, the contradiction is readily explained if 1) non-aggregate forms of compound demonstrate antimicrobial activity but aggregated molecules do not and 2) the number of molecules in the aggregate measurably exceeds the number of non-aggregate molecules. If the phenomenon occurs, it may be possible to define in terms of measurably different MIC values for a compound in the presence of different solvents (water, DMSO and ethanol). DMSO and ethanol are measurably less polar than is water and so there should be less propensity for molecules to aggregate.

Evidence for the formation of such aggregates exists. Thermodynamic constraints dictate that the aggregates can only form when a certain density of the solute is obtained and that the aggregate need number 100 molecules. Molecules so aggregated would not be expected to penetrate the unstirred boundary layer at the surface of an organism. In certain instances, the addition of a cyclodextrin would permit the dispersal of the molecules in the aggregate and would also facilitate passage across the unstirred boundary layer at the surface of microorganisms.

It was discovered that when an otherwise insoluble antimicrobial is part of a cyclodextrin inclusion complex, it may be able to be solubilize in solution to yield a cascade of bio-physical interactions that serve to disrupt the metabolism of spoilage microorganisms so as to prevent their outgrowth. Because the cyclodextrin inclusion complex may allow the antimicrobial to solubilize in the beverage, growth of spoilage microorganisms in a beverage within a sealed container may be inhibited for a period of at least 16 weeks. In addition, because the cyclodextrin may allow the antimicrobial to enter into solution, a lower concentration of the antimicrobial is needed than would be the case if using conventional preservatives. Thus, flavor impact of the preservative system in beverages can be reduced or minimized, and the beverage product of invention possesses surprisingly superior sensory impact, including superior flavor, aroma, and quality, compared to beverages using conventional preservatives.

There is growing demand for use of all natural substances in foods and beverages. Cyclodextrins are natural substances. Compounds that may form complexes with cyclodextrin are also available in all natural state.

Aspects of the invention are directed to an interaction between a cyclodextrin (ligand or host) and a substance with antimicrobial activity (substrate or guest) that results in a complex wherein the complex exhibits characteristics which favor the use of the complex over the substance by itself as an agent to prevent the outgrowth of a range of spoilage organisms in a beverage preservative system for a period of at least 16 weeks.

Cyclodextrins are often employed in the pharmaceutical and cosmetic industry for complex drugs. The cyclodextrin may enhance dissolution, enhance solubility, or enhance efficacy to protect substance from harmful chemical reactions or to provide mitigate the sensory impact of the chemical in complex with the cyclodextrin preservatives. For example, the unfavorable taste of nicotine is mitigated by complex with cyclodextrins allowing the use of the substance in pharmacological compositions employed to reduce craving for cigarettes. Additionally, cyclodextrins can reduce the apparent or observed vapor pressure of volatile substances to which it complexes.

It was not expected that certain antimicrobial compounds would complex with cyclodextrin in a manner that would be appropriate for use as a beverage preservative. Not only would the compound need to complex with a cyclodextrin in a quantity that is sufficient to serve as a preservative, it would need to remain stable for a period of time necessary to function as a preservative and not negatively impact the taste or other sensory attributes of the product. For instance, a molecule may readily bond to cyclodextrin (more soluble) but, once in solution, may not release from the cyclodextrin in quantities sufficient to kill microorganisms.

Aspects of the invention provide improved antimicrobial efficacy, lowered concentrations of preservatives required for product stabilization, improved sensory impact of antimicrobial substances, and improved rate of dissolution of antimicrobial agent into solution of concentrates, blending operations, or finished beverage.

In accordance with aspects of the invention, one or more chemicals from Table I will form complexes with one or more cyclodextrins listed in Table II. The antimicrobial effect of the substance from Table I is enhanced over and beyond what is observed for the same chemical in the absence of cyclodextrin. Moreover, the chemical stability of the substance from Table I is enhanced over and beyond what is observed for the same chemical in the absence of cyclodextrin. For instance, it is known that sorbic acid degrades rapidly in aqueous solution. Sorbic acid in complex with cyclodextrin should prove more stable and this may allow the use of lower concentrations of sorbic acid as a preservative.

Furthermore, unfavorable sensory characteristics of the substance from Table I may be mitigated relative to what is observed for the same chemical in the absence of cyclodextrin.

The rate of dissolution of the substance from Table I may be enhanced relative to what is observed for the same chemical in the absence of cyclodextrin. For instance, it is known that sorbic acid, as the acid, is very slow to enter solution even when put straight into water. On occasion, weak acid preservatives such as benzoic acid, sorbic acid or cinnamic acid will “salt out” of solution when other components are added to quickly (such as acids). Sorbic acid degrades rapidly in aqueous solution. Substances in complex with cyclodextrins are generally more inclined to enter solution and to do so at a more rapid rate.

Cyclodextrins are cyclic oligosaccharides (sugar) possessing a hollow cone like structure, much like that found with a donut. Chemicals possessing certain physical properties with regard to size, hydrophobicity, polarity and surface area can be caused to interact with functional groups contained within the hollow of the cyclodextrin such that the guest molecule becomes encompassed by the ring or donut of the cyclodextrin. Often, this interaction serves to mask one or more physical or chemical characteristics of the guest molecule. To the degree that the masked characteristics are unfavorable with regard to a particular function, the complex offers an advantage over the un-complexed molecule. On occasion, guest molecules may also interact with side groups on the exterior of the cyclodextrin. The interaction results in the formation of a complex. Herein the cyclodextrin is referred to as the ligand or host and the molecule which interacts with the cyclodextrin is the guest or solute. The ratio of host to guest is typically 1:1 or 2:1 but other ratios are feasible.

| Cyclodextrin (CD) | Abbrevation |
|---|---|
| α-cyclodextrin | α-CD |
| β-cyclodextrin | β-CD |
| γ-cyclodextrin | γ-CD |
| Hydroxyethyl-β-CD | HE-p-CD |
| Hydroxypropyl-β-CD | HP-β-CD |
| Sulfobutylether-β-CD | SBE-β-CD |
| Methyl-β-CD | M-β-CD |
| Dimethyl-β-CD | DM-β-CD |
| | (DIMEB) |
| Randomly dimethylated-β-CD | RDM-β-CD |
| Randomly methylated-β-CD | RM-β-CD |
| | (RAMEB) |
| Carboxymethyl-β-CD | CM-β-CD |
| Carboxymethyl ethyl-β-CD | CME-β-CD |
| Diethyl-β-CD | DE-β-CD |
| Tri-O-methyl-β-CD | TRIMEB |
| Tri-O-ethyl-β-CD | TE-β-CD |
| Tri-O-butyryl-β-CD | TB-β-CD |
| Tri-O-valeryl-β-CD | TV-β-CD |
| Di-O-hexanoyl-β-CD | DH-β-CD |
| Glucosyl-β-CD | G₁-β-CD |
| Maltosyl-β-CD | G₂-β-CD |
| 2-hydroxy-3-trimethyl-ammoniopropyl- | HTMAPCD |
| β-CD | |

Certain compounds possess activity as antimicrobials but also possess secondary characteristics that do not favor their use as ingredients in a beverage wherein their principle function would be to prevent the outgrowth of spoilage organisms during the specified shelf life period of the beverage. For instance, a substance may possess antimicrobial activity at a concentration which exceeds its solubility in the beverage. Another compound may possess antimicrobial activity, but may degrade in an aqueous system faster than it is able to cause the destruction of all potential spoilage organisms.

Cyclodextrins overcome these short-comings and others (taste, stability, sensitivity to light) allowing the use of specific molecules in complex with cyclodextrin to perform in preventing the outgrowth of spoilage organisms for a period of at least 16 weeks.

Although the chemistry of cyclodextrins is well established, there is only a limited degree of understanding among experts in the field about how to predict whether a molecule might interact with a cyclodextrin molecule to form a complex and the extent of the interaction. Much less understanding exists regarding the extent to which a complex might overcome a particular shortcoming of the guest molecule with regard to desired end result. Even less is understood about how a complex (host and guest) interact with other components contained within a system. By virtue of these facts, the host-guest relationships defined here for use as preservatives are unique and non-obvious.

Aspects of the invention are directed to preserve a broad range of beverage products that possess a pH of less than 2.5 to 7.5, in particular 2.5 to 4.5 against spoilage by yeast, mold and a range of acid tolerant bacteria. Preservation of product can be accomplished merely through the addition of the chemical agents described herein, but it is also possible to supplement the action of the chemicals with purely physical forms of preservation such as heat, various wavelengths of irradiation, pressure or combinations thereof.

The pH of the preservative system in and of itself is not particularly relevant. Only a very small amount will be added to beverage and the pH of the beverage will dominate. The pH of the beverage containing the preservative system can be adjusted to any specified value. The preservative system should be functional at the specified pH. The cyclodextrin, the antimicrobial substances, and the inclusion complex are generally not subject to degradation that is a consequence of pH alone although the fraction of anti-microbial that is “included” may be subject to effects of pH.

Two chemicals are brought together in such a fashion as to result in the formation of a complex. One of the chemicals in the complex is a cyclodextrin of the type listed in Table I. The other chemical in the complex is a substance with known antimicrobial activity such as listed in Table II. However, not all of the antimicrobials listed may be suitable for all temperatures ranges. It was discovered that certain antimicrobials are particularly suitable for forming the complex as well as effective as a beverage preservative in the complex form.

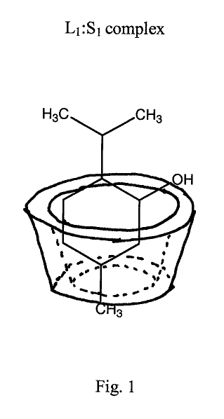

Generally, the complex will exist such that the ratio of antimicrobial to cyclodextrin is 1:1. However, it is possible that other ratios will exist including 1:2, 1:3, 1:4, 2:1, 2:3, and 3:1. A 1:1 type of complex is represented by FIG. 1 wherein a single molecule of a chemical from Table II (schematic ring structure) fits within the cavity of a single molecule (hollow cone) from the list of Table I.

TABLE I
Forms of Cyclodextrin that are representative
of all cyclodextrin forms

| Cyclodextrin Name | Abbreviation |
|---|---|
| β-cyclodextrin | β CD |
| α-cyclodextrin | A CD |
| sulfobutyl ether β-cyclodextrin | (SBE β CD) |
| hydroxypropyl β-cyclodextrin | HP β CD |
| randomly methylated β-cyclodextrin | RM β CD |
| maltosyl/dimaltosyl β-cyclodextrin | M/DM/β CD |

TABLE II
ANTIMICROBIAL CANDIDATES

| | CAS | | SIGMA | MIC |
|---|---|---|---|---|
| | NUMBER | COMMON NAME | CAT # | ppm |
| 1 | 94-18-8 | Benzyl-4-hydroxbenzoate | 54670 | 68 |
| 2 | 104-55-2 | Cinnamaldehyde | W228605 | 66 |
| 3 | 110861-66-0 | Cyclohexanebutyric acid | 228141 | 68 |
| 4 | 21722-83-8 | 2-Cyclohexylethyl acetate | W234818 | 102 |
| 5 | 112-31-2 | Decanal | W236209 | 47 |
| 6 | 112-30-1 | 1-Decanol | W236500 | 24 |
| 7 | 1504-74-1 | o-methoxycinnamylaldehyde | W318108 | 58 |
| 8 | 1731 -84-6 | Methyl nonaoate | W272418 | 90 |
| 9 | 25152-84-5 | Trans, trans, 2,4 decadienal | W313505 | 8 |
| 10 | 112-05-0 | Nonanoic acid | W278408 | 63 |
| 11 | 104-61-0 | [symbol] Nonanoic lactone | W278106 | 63 |
| 12 | 2315-68-6 | Propyl benzoate | 307009 | 66 |
| 13 | 104-67-6 | [symbol] - Undecalactone | U806 | 28 |
| 14 | 112-44-7 | Undecanal | W309206 | 34 |
| 15 | 101-39-3 | [symbol] methyl trans | 112275 | 58.4 |
| | | cinnamylaldehyde | | |
| 16 | 18031-40-8 | perillaldehyde | W355704 | 500 |
| 17 | 89-83-8 | thymol | W306606 | 250 |
| 18 | 103-41-3 | Cinnamic acid benzyl ester | W214205 | ? |
| 19 | 140-10-3 | Cinnamic acid | W214205 | 300 |
| 20 | 116-44-1 | Sorbic acid | W392103 | 1200 |
| 21 | 99-76-3 | Methyl paraban | W271004 | ? |
| 22 | 94-13-3 | Propyl paraban | W295101 | ? |
| 23 | 89-82-7 | Pluegone (R−) (+) | W296309 | ? |
| 24 | 106-22-9 | citronellol | W230901 | ? |
| 25 | 5392-40-5 | Cital | W230308 | ? |
| 26 | 97-53-8 | Eugenol | W246700 | ? |
| 27 | 94-26-8 | Butyl paraben | W220302 | ? |
| 28 | 120-47-8 | Ethyl paraben | 54660 | ? |
| 29 | 93-15-2 | Eugenol methyl ester | 46110 | ? |
| 30 | 5989-27-5 | (R) - limonene | W263303 | ? |

[symbol]

indicates data missing or illegible when filed

Allowing the letter L in FIG. 1 to represent a compound from Table I and the letter S to represent a compound from Table II, the complex can be represented as Lₙ:Sₙ wherein subscript n is the number of either L or S that is party to the complex. When one molecule of L forms a complex with one molecule of S, the complex is 1:1 with respect to L and S and the complex can be abbreviated L₁S₁. Generally speaking, the form L₁S₁ will predominate, but it is permissible for slight variation to occur in the ratio of compounds from Table I relative to compounds from Table II. Non-inclusive examples of other complex forms include L₁S₂ L₁S₃, or L₂S₁ L₃S₁ or L₂S₂ and L₃S₃.

When engaged into a complex, the chemicals from Table II exhibit different characteristics from same un-complexed forms of the same compounds. Characteristics that may be exhibited by compounds from Table I when in complex with cyclodextrin include 1) enhanced antimicrobial activity of compounds relative to the free form of the chemical, 2) enhanced solubility, 3) enhanced rate of dissolution into aqueous solution, and 4) enhanced stability of chemicals in beverage. Enhanced stability might reflect protection from enzymatic degradation, protection from photochemical reactions or protection from physical agents such as heat or pressure. 5) Improved or more favorable sensory characteristics (aroma or flavor).

Exhibition of one or more of these five characteristics is favorable in the application of a cyclodextrin-antimicrobial complex as a preservative agent in beverage products.

In the present invention, the antimicrobial is present in the beverage at a concentration of between about 10 mg/L and about 1000 mg/L, about 20 mg/L and about 800 mg/L, about 30 mg/L and about 600 mg/L, 50 mg/L and 500 mg/L, about 75 mg/L and about 250 mg/L, and about 100 mg/L and about 200 mg/L.

As commonly understood in the art, the definitions of the terms “preserve”, “preservative”, and “preservation” do not provide a standard time period for how long the thing to be preserved is kept from spoilage, decomposition, or discoloration. The time period for “preservation” can vary greatly depending on the subject matter. Without a stated time period, it can be difficult or impossible to infer the time period required for a composition to act as a “preservative.”

As used herein, the terms “preserve”, “preservative”, and “preservation” refer to a food or beverage product protected against or a composition able to inhibit the growth of spoilage microorganisms for a period of at least 16 weeks. Typically, the product is preserved under ambient conditions, which include the full range of temperatures experienced during storage, transport, and display (e.g., 0° C. to 40° C., 10C to 30° C., 20° C. to 25° C.) without limitation to the length of exposure to any given temperature.

“Minimal inhibitory concentration” (MIC) is another term for which no standard time period is included in the definition. Typically, MIC describes the concentration of a substance which measurably inhibits the growth of a single type of microorganism as compared to a positive control without the substance. Any given MIC does not imply a specific time period over which inhibition needs to occur. A substance may exhibit an observable MIC during the first 24 hours of an experiment, but exhibit no measurable MIC relative to the positive control after 48 hours.

In general, the beverage preservative system or beverage product of invention should have a total concentration of chromium, aluminum, nickel, zinc, copper, manganese, cobalt, calcium, magnesium, and iron cations in the range of about 1.0 mM or less, e.g., about 0.5 mM to 0.75 mM, about 0.54 mM or less. The present invention may optionally include added water that has been treated to remove metal cations. As opposed to the teachings of U.S. Pat. No. 6,268,003, the preferred method of treatment is via physical processes such as reverse osmosis and or electro-deionization. Treatment by chemical means, as taught in U.S. Pat. No. 6,268,003 is acceptable, but is not preferred. The use of chemical means to reduce water hardness often results in an increase in the concentration of specific mono-valent cations, e.g., potassium cations, that serve to compromise the invention described herein. In certain exemplary embodiments, the added water has been treated by reverse osmosis, electro-deionization or both to decrease the total concentration of metal cations of chromium, aluminum, nickel, zinc, copper, manganese, cobalt, calcium, magnesium, and iron to about 1.0 mM or less.

Certain exemplary embodiments of the present invention include a mono-terpene and/or a weak acid, each having an octanol/water partition coefficient Log P in the range of 1.1 to 5.0, which has been found to disrupt cellular function as assayed by methods such as flow cytometry. The weak acid should predominantly exist in its protonated form at a pH below 4. Non-limiting examples of such weak acids are trans-cinnamic acid and sorbic acid. Additionally, esters of hydroxybenzoic acid may be included. When included with sequestrants in the beverage preservative systems and beverage products of invention, lower than expected concentrations of mono-terpene and/or weak acid are required for a preservative effect. It is believed that metal cations which are bound by sequestrants are then unavailable to degrade the mono-terpenes and/or weak acids, and render the cell membranes of microorganisms more permeable to these anti-microbial compounds. Certain exemplary embodiments of the present invention include the mono-terpene, the weak acid, or a mixture thereof at a concentration in the range of about 500 mg/L or less, e.g., about 150 mg/L or less, about 25 mg/L to about 200 mg/L. Certain exemplary embodiments of the present invention include trans-cinnamic acid at a concentration in the range of about 50 mg/L to about 150 mg/L. Certain exemplary embodiments of the present invention include sorbic acid at a concentration in the range of about 500 mg/L to about 800 ppm.

Certain exemplary embodiments of the beverage preservative system or beverage product of invention have minimal levels of potassium cation. A lack of potassium cations prevents microorganisms from actively expelling preservatives such as mono-terpenes, weak acids, and esters of hydroxybenzoic acid, thus enhancing the anti-microbial effect of these preservatives. This factor is one of the reasons why it is preferred that treatment of added water should not include chemical methods such as ion-exchange that can lead to increased concentration of potassium ion. In certain exemplary embodiments, the concentration of potassium ion is about 150 mg/L or less, e.g. about 75 mg/L or less, about 15 mg/L or less.

Beverage products according to the present invention include both still and carbonated beverages. Herein, the term carbonated beverage is inclusive of any combination of water, juice, flavor and sweetener that is meant to be consumed as an alcohol free liquid and which also is made to possess a carbon dioxide concentration of 0.2 volumes of CO₂ or greater. The term “volume of CO₂” is understood to mean a quantity of carbon dioxide absorbed into the liquid wherein one volume CO₂ is equal to 1.96 grams of carbon dioxide (CO₂) per liter of product (0.0455M) at 25° C. Non-inclusive examples of carbonated beverages include flavored seltzer waters, juices, cola, lemon-lime, ginger ale, and root beer beverages which are carbonated in the manner of soft drinks, as well as beverages that provide health or wellness benefits from the presence of metabolically active substances, such as vitamins, amino acids, proteins, carbohydrates, lipids, or polymers thereof. Such products may also be formulated to contain milk, coffee, or tea or other botanical solids. It is also possible to formulate such beverages to contain one or more nutraceuticals. Herein, a “nutraceutical” is a substance that has been shown to possess, minimally, either a general or specific health benefit or sense of wellness as documented in professional journals or texts. Nutraceuticals, however, do not necessarily act to either cure or prevent specific types of medical conditions.

Herein, the term “still beverage” is any combination of water and ingredient which is meant to be consumed in the manner of an alcohol free liquid beverage and which possesses no greater than 0.2 volumes of carbon dioxide. Non-inclusive examples of still beverages include flavored waters, tea, coffee, nectars, mineral drinks, sports beverages, vitamin waters, juice-containing beverages, punches or the concentrated forms of these beverages, as well as beverage concentrates which contain at least about 45% by weight of juice. Such beverages may be supplemented with vitamins, amino acids, protein-based, carbohydrate-based or lipid-based substances. As noted, the invention includes juice containing products, whether carbonated or still. “Juice containing beverages” or “Juice beverages”, regardless of whether still or carbonated, are products containing some or all the components of a fruit, vegetable or nuts or mixture thereof that can either be suspended or made soluble in the natural liquid fraction of the fruit.

The term “vegetable”, when used herein, is include both fruiting and non-fruiting but edible portion of plants such as tubers, leaves, rinds, and also, if not otherwise indicated, any grains, nuts, beans, and sprouts which are provided as juices or beverage flavorings. Unless dictated by local, national, or regional regulatory agencies the selective removal of certain substances (pulp, pectins, etc) does not constitute an adulteration of a juice.

By way of example, juice products and juice drinks can be obtained from the fruit of apple, cranberry, pear, peach, plum, apricot, nectarine, grape, cherry, currant, raspberry, goose-berry, blackberry, blueberry, strawberry, lemon, orange, grapefruit, passionfruit, mandarin, mirabelle, tomato, lettuce, celery, spinach, cabbage, watercress, dandelion, rhubarb, carrot, beet, cucumber, pineapple, custard-apple, coconut, pomegranate, guava, kiwi, mango, papaya, watermelon, lo han guo, cantaloupe, pineapple, banana or banana puree, lemon, mango, papaya, lime, tangerine, and mixtures thereof. Preferred juices are the citrus juices, and most preferred are the non-citrus juices, apple, pear, cranberry, strawberry, grape, papaya, mango and cherry.

Not all ranges of juice concentration can be employed. The invention could be used to preserve a formulation that is essentially 100% juice if then the presence of specific metal cation species is not exceeded. Another possibility would be to treat the juice in such a manner as to lower the concentration of specific metal cation species. Similar issues arise for juice beverages, which typically contain at least 95% juice. Formulations containing juice concentrations as high as 10% may be preserved by this invention and certainly a beverage containing less than 10% juice or less than 5% would be very likely preserved by this invention. If a beverage concentrate is desired, the fruit juice is concentrated by conventional means from about 20° Brix to about 80° Brix. Beverage concentrates are usually 40° Brix or higher (about 40% to about 75% sugar solids).

Typically, beverages will possess a specified range of acidity. Acidity of a beverage is largely determined by the type of acidulant, its concentration, and the propensity of protons associated with the acid to dissociate away from the acid when the acid is entered into solution. Any solution with a measurable pH between 0-14 possesses some measure of acidity. However, those solutions with pH below 7 are generally understood to be acidic and those above pH 7 are understood to be basic. The acidulant can be organic or inorganic. Non-exclusive examples of organic acids are citric, malic, ascorbic, tartaric, lactic, gluconic, and succinic acids. Non-exclusive examples of inorganic acids are the phosphoric acid compounds and the mono- and di-potassium salts of these acids. (Mono- and di-potassium salts of phosphoric acid possess at least one proton that can contribute to acidity).

The various acids can be combined with salts of the same or different acids in order to manage pH or the buffer capacity of the beverage to a specified pH or range of pH. The invention can function at a pH as low as 2.6, but the invention will function best as the pH is increased from 2.6 up to pH 3.8. The invention is not limited by the type of acidulant employed in acidifying the product as long as the final pH of the product does not exceed pH 4.5. Virtually any organic acid salt can be used so long as it is edible and does not provide an off-flavor. The choice of salt or salt mixture will be determined by the solubility and the taste. Citrate, malate and ascorbate yield ingestible complexes whose flavors are judged to be quite acceptable, particularly in fruit juice beverages. Tartaric acid is acceptable, particularly in grape juice beverages, as is lactic acid. Longer-chain fatty acids may be used but can affect flavor and water solubility. For essentially all purposes, the malate, gluconate, citrate and ascorbate moieties suffice.

Certain exemplary embodiments of the beverage product of invention include sports (electrolyte balancing) beverages (carbonated or non-carbonated). Typical sport beverages contain water, sucrose syrup, glucose-fructose syrup, and natural or artificial flavors. These beverages can also contain sodium chloride, citric acid, sodium citrate, mono-potassium phosphate, as well as other natural or artificial substances which serve to replenish the balance of electrolytes lost during perspiration.

In certain exemplary embodiments, the present invention also includes beverage formulations supplemented with fat soluble vitamins. Non-exclusive examples of vitamins include fat-soluble vitamin E or its esters, vitamin A or its esters, vitamin K, and vitamin D3, especially vitamin E and vitamin E acetate. The form of the supplement can be powder, gel or liquid or a combination thereof. Fat-soluble vitamins may be added in a restorative amount, i.e. enough to replace vitamin naturally present in a beverage such as juice or milk, which may have been lost or inactivated during processing. Fat-soluble vitamins may also be added in a nutritionally supplemental amount, i.e. an amount of vitamin considered advisable for a child or adult to consume based on RDAs and other such standards, preferably from about one to three times the RDA (Recommended Daily Amount). Other vitamins which can be added to the beverages include vitamin B niacin, pantothenic acid, folic acid, vitamin D, vitamin E, vitamin B and thiamine. These vitamins can be added at levels from 10% to 300% RDA. It should be recognized that a potential exists for some types of guest molecules or complexes to become entrapped into certain types of micelles, liposomes, or fat globules but this can only be characterized on a case by case basis.

Supplements: The invention can be compromised by the presence of certain types of supplements but it is not an absolute and it will vary from beverage formulation to beverage formulation. The degree to which the invention is compromised will depend on the nature of the supplement and the resulting concentration of specific metal cations in the beverage as a consequence of the presence of the supplement. For example, calcium supplements can compromise the invention, but not to the same degree as chromium supplements. Calcium supplements may be added to the degree that a critical value total calcium concentration is not exceeded (e.g., ⅓ to ½ the molar concentration of diphosphonic acid in the beverage). Calcium sources that are compatible with the invention include calcium organic acid complexes. Among the preferred calcium sources is “calcium citrate-malate”, as described in U.S. Pat. No. 4,786,510 and U.S. Pat. No. 4,786,518 issued to Nakel et al. (1988) and U.S. Pat. No. 4,722,847 issued to Heckert (1988). Other calcium sources compatible with the invention include calcium acetate, calcium tartrate, calcium lactate, calcium malate, calcium citrate, calcium phosphate, calcium orotate, and mixtures thereof. Calcium chloride and calcium sulfate can also be included; however at higher levels they taste astringent.

Flavor Component: Beverage products according to the present invention can contain flavors of any type. The flavor component of the present invention contains flavors selected from artificial, natural flavors, botanical flavors fruit flavors and mixtures thereof. The term “botanical flavor” refers to flavors derived from parts of a plant other than the fruit; i.e. derived from bean, nuts, bark, roots and leaves. Also included within the term “botanical flavor” are synthetically prepared flavors made to simulate botanical flavors derived from natural sources. Examples of such flavors include cocoa, chocolate, vanilla, coffee, kola, tea, and the like. Botanical flavors can be derived from natural sources such as essential oils and extracts, or can be synthetically prepared. The term “fruit flavors” refers to those flavors derived from the edible reproductive part of a seed plant, especially one having a sweet pulp associated with the seed. Also included within the term “fruit flavor” are synthetically prepared flavors made to simulate fruit flavors derived from natural sources.

Artificial flavors can also be employed. Non-exclusive examples of artificial flavors include chocolate, strawberry, vanilla, cola, or artificial flavors that mimic a natural flavor can be used to formulate a still or carbonated beverage flavored to taste like fruit. The particular amount of the flavor component effective for imparting flavor characteristics to the beverage mixes of the present invention (“flavor enhancing”) can depend upon the flavor(s) selected, the flavor impression desired, and the form of the flavor component. The flavor component can comprise at least 0.005% by weight of the beverage com position.

On a case by case basis, the beverage preservative system according to the present invention is compatible with beverages formulated to contain aqueous essence. As used herein, the term “aqueous essence” refers to the water soluble aroma and flavor materials which are derived from fruit juices. Aqueous essences can be fractionated, concentrated or folded essences, or enriched with added components. As used herein, the term “essence oil” refers to the oil or water insoluble fraction of the aroma and flavor volatiles obtained from juices. Orange essence oil is the oily fraction which separates from the aqueous essence obtained by evaporation of orange juice. Essence oil can be fractionated, concentrated or enriched. As used herein, the term “peel oil” refers to the aroma and flavor derived from oranges and other citrus fruit and is largely composed of terpene hydrocarbons, e.g. aliphatic aldehydes and ketones, oxygenated terpenes and sesquiterpenes. From about 0.002% to about 1.0% of aqueous essence and essence oil are used in citrus flavored juices.

Sweetener Component: The present invention is not affected by the type or concentration of sweeteners. The sweetener may be any sweetener commonly employed for use in beverages. The sweetener can include a monosaccharide or a disaccharide. A certain degree of purity from contamination by metal cations will be expected. Peptides possessing sweet taste are also permitted. The most commonly employed saccharides include sucrose, fructose, dextrose, maltose and lactose and invert sugar. Mixtures of these sugars can be used. Other natural carbohydrates can be used if less or more sweetness is desired. Other types of natural sweeteners structured from carbon, hydrogen and oxygen, e.g., rebaudioside A, stevioside, Lo Han Guo, mogroside V, monatin, can also be used. The present invention is also compatible with artificial sweeteners. By way of example, artificial sweeteners include saccharin, cyclamates, acetosulfam, mogroside, Laspartyl-L-phenylalanine lower alkyl ester sweeteners (e.g. aspartame), L-aspartyl-D-alanine amides as disclosed in U.S. Pat. No. 4,411,925 to Brennan et al. (1983), L-aspartyl-D-serine amides as disclosed in U.S. Pat. No. 4,399,163 to Brennan et al., (1983), L-aspartyl-L-lhydroxymethyl alkaneamide sweeteners as disclosed in U.S. Pat. No. 4,338,346 to Brand, issued Dec. 21, 1982, L-aspartyl-l-hydroxy ethylakaneamide sweeteners as disclosed in U.S. Pat. No. 4,423,029 to Rizzi, (1983), L-aspartyl-D-phenylglycine ester and amide sweeteners as disclosed in European Patent Application 168,112 to J. M. Janusz, published Jan. 15, 1986, and the like. A particularly preferred sweetener is aspartame. The amount of the sweetener effective in the beverage mixes of the invention depends upon the particular sweetener used and the sweetness intensity desired.

Head space atmosphere: The presence of either air in the headspace of the beverage product will have no measurable impact on the composition of the invention. The presence of carbon dioxide gas or other gases that cause the exclusion of oxygen from the beverage (nitrogen, nitrous oxide, etc) may permit the use of reduced concentrations of chemical preservatives employed along with the sequestrants. The concentration of sequestrants required will be dictated only by the type and amount of metal cations that are present in the beverage product.

The following example is a specific embodiment of the present invention, but is not intended to limit it. Any patent document referenced herein is incorporated in its entirety for all purposes.

### Examples

The invention recognizes a multitude of criteria regarding the interaction between cyclodextrins and the molecule that exhibits antimicrobial activity. In preparing examples, the following is taken into consideration.

First, the molecule to be included by cyclodextrin must be shown to exhibit anti-microbial activity. The intent of the invention is to employ the lowest concentration of these compounds as is possible without compromise to the requirement that product is stable for a period of 16 weeks. Another feature of the invention may be the masking of the sensory impact of the compound which exhibits anti-microbial activity.

Second, the molecule must possess a volume dimension that is consistent with the volume available inside the cavity of the cyclodextrin. The calculated volume in cubic angstroms (Å³) of the 3 classes of cyclodextrin are 174, 262 and 472 for α, β and γ cyclodextrins respectively. All listed compounds in Table III possess calculated volumes of less than 230 Å³.

Third, candidate compounds must demonstrate a measurable degree of apolar structure. Such can be estimated from the calculation of Topological Polar Surface Area (TPSA) expressed in units of Angstrom square (Å²). TPSA is the sum of the surface contributions of polar atoms (usually oxygens, nitrogens and attached hydrogens). TPSA is one of many Quantitative Structure Activity Relationships (QSAR) factors that can determine the physical state or activity of a molecule. The most preferred value for TPSA is between 1 and 40 Å². Less preferred, but measurably acceptable, is a TPSA value of 40-100 Å². Although not preferred, a TPSA of >100 does not completely rule out the candidacy of a molecule. For instance, a molecule such as chloramphenicol exhibits a relatively high TPSA value (115.378) but the other QSAR factors permit a relatively good fit of chloramphenicol with β cyclodextrins. The highest TPSA value of any compound in Table III is 60 Å². The majority of compounds exhibit a TPSA of less than 40 Å².

Fourth, candidate compounds generally exhibit relatively low water solubility. Solubility of candidate compounds is first characterized by calculation using the General Solubility Equation (Yalkowsky). The candidate compound for complexation should possess solubility values (Log S) in the range of:
−5<Log S−3
   Less preferred, but still measurably acceptable, is a range of Log S
−5<Log S<−2.0
   Less preferred, but still acceptable is a range of Log S such that
−5<Log S<−1.0
   About 3 of the candidate compounds exhibit a Log S of <−3.00. Approximately half the compounds exhibit a Log S of <−2.00 and the remainder of the candidate compounds exhibit a −2<Log S<−1.0.

In each of the examples below, the period of incubation is 16 weeks which relates to the standard shelf life period for beverages distributed at ambient temperature. If a chemical simply retards growth for a period less than 16 weeks, then it will not fulfill the need of the manufacturer. The concentration of the chemical employed to prohibit spoilage is often reported as the Minimum Inhibitory Concentration (MIC). The MIC value of a candidate compound for use as a beverage preservative is the concentration of the candidate which permits the beverage to remain free of spoilage for a period of 16 weeks. Many natural substances that possess antifungal activity, such as essential oils, are inclined to exhibit limited solubility in water aqueous systems such a beverages. The limit of solubility for many such compounds prohibits their use as preservatives. Otherwise stated, MIC value exceeds the limit of solubility. The invention permits the use of otherwise un-employable natural or synthetic antimicrobial substances as preservatives.

### Example 1

A model high acid beverage system (pH <4.6) of 10% juice content was prepared to test efficacy of propyl paraben either in the non-complex form or as the alpha (α) or beta (β) cyclodextrin-included (complex) form. The base composition of the model beverage per liter is:

| Model Beverage Ingredient | Contribution to beverage |
|---|---|
| Dextrose | 5.2% |
| Sucrose | 6.8% |
| Fructose | 0.2% |
| Malic Acid | 0.05% |
| Sodium Malate | 0.04% |
| Apple Juice Concentrate 70 Brix | 0.143% (yielding 10% single |
| | strength) |
| Calcium Chloride dihydrate | 0.0039% |
| Magnesium Chloride hexahydrate | 0.0027% |
| Reverse Osmosis Treated Water | Balance |

In the above model beverage system (pH 3.4), propyl paraben exhibited a solubility limit of 368 mg/L. At this concentration, propyl paraben was not effective as a stand alone chemical preservative in the test beverage. When presented to beverage in the form of a complex with alpha or beta cyclodextrin, the solubility of propyl paraben was extended to as high as 780 mg/L. The amount of propyl paraben in complex with cyclodextrin that is required to inhibit growth of 3 different spoilage yeast is 600 mg/L when in complex with β-cyclodextrin and 510 mg/L when in complex with α-cyclodextrin. Concentrations of propyl paraben in the form of a complex sufficient to prohibit outgrowth of spoilage organisms require 15 mmol (1.45%) of α-cyclodextrin or 4 mmol (0.56%) of β-cyclodextrin. The strains of yeast employed in the study were Saccharomyces cerevisiae, Zygosaccharomyces balii and Zygosaccharomyces bisporus.

### Example 2

A model low acid beverage system (pH ≧4.6) with high water activity (>0.97) was prepared to test efficacy of propyl paraben either in the non-complex form or as the alpha (α) or beta (β) cyclodextrin-included (complex) form. The base composition of the model beverage per liter is:

| Model Beverage Ingredient | Contribution to beverage |
|---|---|
| Sucralose | 0.006% |
| Potassium Acesulfame | 0.004% |
| Folic Acid | 0.002% |
| Vitamin E acetate | 0.002% |
| Antifoam | 0.01% |
| Ascorbic acid | 0.02% |
| Melon Flavor | 0.0019% |
| Succinate | 0.0017% |
| Sodium Succinate | 0.0047% |
| Calcium Chloride dihydrate | 0.0039% |
| Magnesium Chloride hexahydrate | 0.0027% |
| Reverse Osmosis Treated Water | Balance |

In the above model beverage system (pH 5.8), propyl paraben exhibited solubility limit of 426 mg/L. At this concentration, propyl paraben was not effective as a stand alone chemical preservative in the test beverage. When presented to beverage in the form of a complex with alpha or beta cyclodextrin, the solubility of propyl paraben was extended to as high as 750 mg/L. The amount of propyl paraben in complex with cyclodextrin that is required to inhibit growth of 3 different spoilage yeast is 650 mg/L when in complex with β-cyclodextrin and 510 mg/L when in complex with α-cyclodextrin. The enhancement of solubility for propyl paraben in the form of a complex sufficient to prohibit outgrowth of spoilage organisms require 15 mmol (1.45%) of α-cyclodextrin or 4 mmol (0.56%) of β-cyclodextrin. The strains of yeast employed in the study were Saccharomyces cerevisiae, Zygosaccharomyces balii and Zygosaccharomyces bisporus.

### Example 3

A model high acid beverage system (pH <4.6) of 10% juice content was prepared to test efficacy of methoxycinnamate either in the non-complex form or as the alpha (α) or beta (β) cyclodextrin-included (complex) form. The base composition of the model beverage per liter is:

| Model Beverage Ingredient | Contribution to beverage |
|---|---|
| Dextrose | 5.2% |
| Sucrose | 6.8% |
| Fructose | 0.2% |
| Malic Acid | 0.05% |
| Sodium Malate | 0.04% |
| Grape Juice Concentrate 65 Brix | 0.154% (yielding 10% single |
| | strength) |
| Calcium Chloride dihydrate | 0.0039% |
| Magnesium Chloride hexahydrate | 0.0027% |
| Reverse Osmosis Treated Water | Balance |

In the above model beverage system (pH 3.4), methoxycinnamate exhibited a solubility limit of 498 mg/L. At this concentration, methoxycinnamate was not effective as a stand alone chemical preservative in the test beverage. When presented to beverage in the form of a complex with alpha or beta cyclodextrin, the solubility of methoxycinnamate was extended to as high as 3690 mg/L. The amount of methoxycinnamate in complex with cyclodextrin that is required to inhibit growth of 3 different spoilage yeast is 800 mg/L when in complex with α-cyclodextrin and 420 mg/L when in complex with β-cyclodextrin. Precedent exists wherein an antifungal demonstrate enhanced efficacy when presented as a cyclodextrin complex. Enhancement of the solubility of methoxycinnamate in the form of a complex to a concentration sufficient to prohibit outgrowth of spoilage organisms require 15 mmol (1.45%) of α-cyclodextrin or 4 mmol (0.56%) of β-cyclodextrin.

10 mmol (0.9%) of α-cyclodextrin or 3 mmol (0.34%) of β-cyclodextrin is required to provide sufficient concentrations of methoxycinnamate. The strains of yeast employed in the study were Saccharomyces cerevisiae, Zygosaccharomyces bali and Zygosaccharomyces bisporus.

### Example 4

A model low acid beverage system (pH ≧4.6) with high water activity (>0.97) was prepared to test efficacy of methoxycinnamate either in the non-complex form or as the alpha (α) or beta (β) cyclodextrin-included (complex) form. The base composition of the model beverage per liter is:

| Model Beverage Ingredient | Contribution to beverage |
|---|---|
| Tea Solids | 0.15% |
| Honey Granules | 0.03% |
| Flavor | 0.15% |
| Pectin | 0.01% |
| Ascorbic acid | 0.01% |
| Ethylenediamine Tetraacetic acid | 0.003% |
| Succinate | 0.007% |
| Sodium Succinate | 0.0057% |
| Sucralose | 0.006% |
| Potassium Acesulfame | 0.004% |
| Calcium Chloride dihydrate | 0.0039% |
| Magnesium Chloride hexahydrate | 0.0027% |
| Reverse Osmosis Treated Water | Balance |

In the above model beverage system (pH 5.3), methoxycinnamate exhibited a solubility limit of 600 mg/L. At this concentration, methoxycinnamate did not prove effective as a stand alone chemical preservative in the test beverage. When presented to beverage in the form of a complex with alpha (α) or beta (β) cyclodextrin, the solubility of methoxycinnamate was extended to as high as 3411 mg/L. The amount of methoxycinnamate in complex with cyclodextrin that is required to inhibit growth of 3 different spoilage yeast is 800 mg/L when in complex with α-cyclodextrin and 420 mg/L when in complex with β-cyclodextrin. Precedent exists wherein an antifungal demonstrate enhanced efficacy when presented as a cyclodextrin complex. 10 mmol (0.9%) of α-cyclodextrin or 3 mmol (0.34%) of β-cyclodextrin is required to provide sufficient concentrations of methoxycinnamate. The strains of yeast employed in the study were Saccharomyces cerevisiae, Zygosaccharomyces balii and Zygosaccharomyces bisporus.

### Example 5

A model high acid beverage system (pH <4.6) of 10% juice content was prepared to test efficacy of trans, trans 2,4 decadienal either in the non-complex form or as the alpha (α) or beta (β) cyclodextrin-included (complex) form. The base composition of the model beverage per liter is:

| Model Beverage Ingredient | Contribution to beverage |
|---|---|
| Dextrose | 5.2% |
| Sucros | 6.8% |
| Fructose | 0.2% |
| Malic Acid | 0.05% |
| Sodium Malate | 0.04% |
| Grape Juice Concentrate 65 Brix | 0.076% (yielding 5% single |
| | strength) |
| Apple Juice Concentrate 70 Brix | 0.072% (yielding 5% single |
| | strength) |
| Calcium Chloride dihydrate | 0.0039% |
| Magnesium Chloride hexahydrate | 0.0027% |
| Reverse Osmosis Treated Water | Balance |

In the above model beverage system (pH 3.4), trans, trans 2,4 decadienal exhibited a solubility limit of 5.4 mg/L. At this concentration, trans, trans 2,4 decadienal was not effective as a stand alone chemical preservative in the test beverage. When presented to beverage in the form of a complex with alpha or beta cyclodextrin, the solubility of trans, trans 2,4 decadienal was extended to as high as 280 mg/L. The amount of trans, trans 2,4 decadienal in complex with cyclodextrin that is required to inhibit growth of 3 different spoilage yeast is 60 mg/L when in complex with a-cyclodextrin and 125 mg/L when in complex with β-cyclodextrin. Concentrations of trans, trans 2,4 decadienal in the form of a complex sufficient to prohibit outgrowth of spoilage organisms require 15 mmol (1.45%) of α-cyclodextrin or 4 mmol (0.56%). The strains of yeast employed in the study were Saccharomyces cerevisiae, Zygosaccharomyces bali and Zygosaccharomyces bisporus.

### Example 6

A model low acid beverage system (pH ≧4.6) with high water activity (>0.97) was prepared to test efficacy of trans, trans 2,4 decadienal either in the non-complex form or as the alpha (α) or beta (β) cyclodextrin-included (complex) form. The base composition of the model beverage per liter is:

| Model Beverage Ingredient | Contribution to beverage |
|---|---|
| Tea Solids | 0.15% |
| Honey Granules | 0.03% |
| Flavor | 0.15% |
| Pectin | 0.01% |
| Ascorbic acid | 0.01% |
| Ethylenediamine Tetraacetic acid | 0.003% |
| Succinate | 0.007% |
| Sodium Succinate | 0.0057% |
| Sucralose | 0.006% |
| Potassium Acesulfame | 0.004% |
| Calcium Chloride dihydrate | 0.0039% |
| Magnesium Chloride hexahydrate | 0.0027% |
| Reverse Osmosis Treated Water | Balance |

In the above model beverage system (pH 5.3), trans, trans 2,4 decadienal exhibited a solubility limit of 5.8 mg/L. At this concentration, trans, trans 2,4 decadienal did not prove effective as a stand alone chemical preservative in the test beverage. When presented to beverage in the form of a complex with alpha (α) or beta (β) cyclodextrin, the solubility of trans, trans 2,4 decadienal was extended to as high as 280 mg/L. The amount of trans, trans 2,4 decadienal in complex with cyclodextrin that is required to inhibit growth of 3 different spoilage yeast is 57 mg/L when in complex with α-cyclodextrin and 123 mg/L when in complex with β-cyclodextrin. 5 mmol (0.49%) of α-cyclodextrin or 4 mmol (0.45%) of β-cyclodextrin is required to provide sufficient concentrations of methoxycinnamate. The strains of yeast employed in the study were Saccharomyces cerevisiae, Zygosaccharomyces balii and Zygosaccharomyces bisporus.

### Summary of Examples

Propyl paraben exhibited a limit of solubility in beverage of 368-426 mg/L. At this concentration, propyl paraben was not effective as a stand alone chemical preservative in the test beverage. When presented to beverage in the form of a complex with alpha or beta cyclodextrin, the solubility of propyl paraben was extended to as high as 750 mg/L which exceeds the amount of propyl paraben in complex that is required to inhibit growth of 3 different spoilage yeast (510-600 ppm).

Methoxycinnamate exhibited a limit of solubility in beverage of 498-600 mg/L. At this concentration, methoxycinnamate was not effective as a stand alone chemical preservative in the test beverage. When presented to beverage in the form of a complex with alpha or beta cyclodextrin, the solubility of methoxycinnamate was extended to as high as 3600 mg/L which exceeds the amount of methoxycinnamate in complex that is required to inhibit growth of 3 different spoilage yeast (400-807 ppm). The apparent reduction of MIC from >600 mg/L to 400 mg/L when in complex with β-cyclodextrin is not without precedent. Not to be bound by theory, but it has been stated that compounds in complex with cyclodextrin can more readily cross the un-disturbed water (boundary) layer that envelopes the spoilage organisms.

Trans, trans 2,4 decadienal exhibited a limit of solubility in beverage of 57 mg/L. At this concentration, trans, trans 2,4 decadienal was not effective as a stand alone chemical preservative in the test beverage. When presented to beverage in the form of a complex with alpha or beta cyclodextrin, the solubility of trans, trans 2,4 decadienal was extended to as high as 280 mg/L which exceeds the amount of trans, trans 2,4 decadienal in complex that is required to inhibit growth of 3 different spoilage yeast (57-124 ppm).

What is claimed is:

1. A beverage comprising:
a beverage component;
an antimicrobially effective amount of a cyclodextrin-antimicrobial complex comprising cyclodextrin and an antimicrobial capable of forming a complex with the cyclodextrin;
a pH of2.5 to 7.5;
wherein the beverage when placed within a sealed container is substantially not spoiled by microorganisms for a period of at least 16 weeks.

2. The beverage of claim 1, wherein the cyclodextrin is selected from the group consisting of β-cyclodextrin, α-cyclodextrin, sulfobutyl ether β-cyclodextrin, hydroxypropyl β-cyclodextrin, randomly methylated β-cyclodextrin, maltosyl/dimaltosyl β-cyclodextrin.

3. The beverage of claim 1, wherein the cyclodextrin is selected from the group consisting of β-cyclodextrin and α-cyclodextrin.

4. The beverage of claim 1, wherein the antimicrobial is selected from the group consisting of trans, trans 2,4 decadienal, propyl paraben, and methoxycinnamate.

5. The beverage of claim 1, wherein the antimicrobial is selected from the group consisting of butyl paraben, sorbic acid, and cinnamic acid.

6. The beverage of claim 1 having a pH in the range of 2.5 to 5.6.

7. The beverage of claim 1 having a pH in the range of 2.5 to 4.6.

8. The beverage of claim 1 wherein the antimicrobial is present in an amount of at least about 10 mg/L and about 1000 mg/L.

9. The beverage of claim 1 wherein the antimicrobial is present in an amount of at least about 25 mg/L and to about 250 mg/L.

10. The beverage of claim 1 further comprising a sequestrant.

11. The beverage of claim 10 wherein the sequestrant is EDTA or EDDS or mixtures thereof.

12. The beverage of claim 1 further comprising at least one polyphosphate or diphosphonic acid.

13. The beverage of claim 1, wherein metal cations of chromium, aluminum, nickel, zinc, copper, manganese, cobalt, calcium, magnesium, and iron are present at a total concentration of 1.0 mM or less.

14. The beverage of claim 1, wherein metal cations of chromium, aluminum, nickel, zinc, copper, manganese, cobalt, calcium, magnesium, and iron are present at a total concentration in the range of 0.5 mM to 0.75 mM.

15. The beverage of claim 1, wherein potassium cation is present at a concentration in the range of 150 mg/L or less.

16. The beverage of claim 1, wherein the beverage component comprises at least one of added water, a juice, a flavorant, a sweetener, an acidulant, a colorant, a vitamin, a buffering agent, a thickener, an emulsifier, and an anti-foaming agent.

17. The beverage of claim 1, wherein the juice is a fruit juice from at least one of orange, grapefruit, lemon, lime, tangerine, apple, grape, cranberry, raspberry, blueberry, strawberry, pineapple, pear, peach, pomegranate, prune, cherry, mango, papaya, lychee, and guava.

18. The beverage of claim 1, wherein the beverage is a carbonated beverage, a non-carbonated beverage, a soft drink, a fruit juice, a fruit juice flavored drink, a fruit-flavored drink, an energy drink, a hydration drink, a sport drink, a health and wellness drink, a fountain beverage, a frozen ready-to-drink beverage, a frozen carbonated beverage, a liquid concentrate, a coffee beverage, a tea beverage, a dairy beverage, a soy beverage, a vegetable drink, a flavored water, an enhanced water, or an alcoholic beverage.
